(19) United States
(12) Patent Application Publication
(10) Pub. No.: US 2013/0069537 A1
(43) Pub. Date: Mar. 21, 2013

(54) PIXEL CIRCUIT AND DRIVING METHOD THEREOF

(71) Applicants: BO-JHANG SUN, Kaohsiung City (TW); Ying-hui Chen, Taoyuan City (TW); Chin-hai Huang, Pingzhen City (TW); Huan-ting Zhou, Sanchong City (TW); Ming-hung Hu, Xiluo Township (TW)

(72) Inventors: BO-JHANG SUN, Kaohsiung City (TW); Ying-hui Chen, Taoyuan City (TW); Chin-hai Huang, Pingzhen City (TW); Huan-ting Zhou, Sanchong City (TW); Ming-hung Hu, Xiluo Township (TW)

(73) Assignee: Chunghwa Picture Tubes, LTD., Bade City (TW)

(21) Appl. No.: 13/345,707

(22) Filed: Jan. 7, 2012

(30) Foreign Application Priority Data
Sep. 19, 2011 (TW) 100133621

(51) Int. Cl. H05B 37/02

(52) U.S. Cl. 315/123

(57) ABSTRACT

The disclosure relates to a pixel circuit which includes an LED, a storage capacitor, a driving transistor, and first to third switching transistors. The driving transistor is utilized to control connection/disconnection between a power supply voltage and the LED. The first switching transistor receives a first scanning signal for controlling connection/disconnection between a gate of the driving transistor and the power supply voltage. The second switching transistor receives a second scanning signal for controlling connection/disconnection between the storage capacity and a ground voltage. The third switching transistor receives the first scanning signal for controlling connection/disconnection between the storage capacity and a data voltage. The first scanning signal and the second scanning signal are in antiphase to each other. A driving method thereof is also disclosed.

### TECHNICAL FIELD OF THE INVENTION

The present invention relates to a pixel circuit and a driving method thereof, more particularly to a pixel circuit of an active-matrix organic light-emitting diode (AMOLED) and a driving method thereof.

### BACKGROUND OF THE INVENTION

A typical pixel circuit of an AMOLED generally employs 2T1C (two thin-film transistors and a storage capacitor) circuit architecture. Referring to FIG. 1, FIG. 1 depicts a schematic drawing illustrating a conventional pixel circuit of an AMOLED. The pixel circuit includes an N-type switching transistor 102, a P-type driving transistor 104, and a storage capacitor Cs. A control electrode of the switching transistor 102 is connected to a scanning line 110. A source thereof is connected to a data line 120, and a drain thereof is connected to a terminal of the storage capacitor Cs. Another terminal of the storage capacitor Cs is connected to a reference voltage Vref. A control electrode of the driving transistor 104 is connected to the terminal of the storage capacitor Cs. A source thereof is connected to a supply voltage Vdd, and a drain thereof is connected to an anode of an organic LED 106. In addition, a cathode of the organic LED 106 is connected to a systemic ground voltage Vss, such as 0 volt.

The driving principle of the conventional pixel circuit is described as follows. When the scanning line 110 provides a scan signal Vscan to turn on the switching transistor 102, a data signal Vdata which represents a grayscale data of an image on the data line 120 is inputted to the terminal of the storage capacitor Cs and is used for controlling the control electrode of the driving transistor 104. Then the driving transistor 104 generates different gate-source voltages Vsg (i.e., Vs−Vg) under different gate voltages Vg for the driving transistor 104 generating various magnitudes of driving currents, in which Vs is the supply voltage Vdd, and Vg is the data signal Vdata. To enable the driving transistor 104 to generate a pixel current passing through the organic LED 106, the gate-source voltage Vsg of the driving transistor 104 must be greater than a threshold voltage of the driving transistor 104. In accordance with Semiconductor Physics, the driving transistor 104 meets the following equation: I_{OLED}=K×(Vsg−|Vth|)², in which I_{OLED} is the pixel current; K is a process parameter of a component; Vsg is the gate-source voltage; and Vth is the threshold voltage.

A voltage source of the AMOLED is coupled to every pixel through wires, so that each of the sources of the driving transistors 104 is coupled to the supply voltage Vdd. However, there are electric currents passing through the wires when driving the organic LED 106 to illuminate. Because there is impedance in the wires, ends of the wires inevitably have a voltage drop (IR drop) phenomenon obeying Ohm's law V=IR. Furthermore, the magnitude of the pixel current I_{OLED} is affected by a decline of the supply voltage Vdd, such that a display panel has a gradient light and a shade distribution; this is especially evident in a large size display.

In addition, the driving transistors on a panel due to non-uniform device processes cause the threshold voltages Vth differences, the brightness, therefore, shows light and shade in every pixel to be in non-uniform effect. In general, new pixel circuits in relevant fields usually employ a coding manner to compensate the above-mentioned drawback, however, the manner generally has a side effect of extending a driving time, thereby can not be applied to high-definition displays.

### SUMMARY OF THE INVENTION

Accordingly, an objective of the present invention is to provide a pixel circuit to improve the problem of the above-mentioned non-uniformity in the panel.

Another objective of the present invention is to provide a driving method of the pixel circuit to improve the problem of the aforesaid non-uniformity in the panel.

To achieve the foregoing objective, a pixel circuit which is provided by a preferred embodiment of the present invention includes an LED, a storage capacitor, a driving transistor, a first switching transistor, a second switching transistor, and a third switching transistor. The storage capacitor herein has a first terminal and a second terminal. The driving transistor has a control electrode and is utilized for driving the LED to illuminate. The control electrode of the driving transistor is electrically coupled to the second terminal of the storage capacitor for controlling connection/disconnection between a supply voltage and the LED. The first switching transistor has a control electrode, and the control electrode of the first switching transistor receives a first scanning signal to control connection/disconnection between the control electrode of the driving transistor and the supply voltage. The second switching transistor has a control electrode, and the control electrode of the second switching transistor receives a second scanning signal to control connection/disconnection between the first terminal of the storage capacitor and a ground voltage. The third switching transistor has a control electrode, and the control electrode of the third switching transistor receives the first scanning signal to control connection/disconnection between the first terminal of the storage capacitor and a data voltage. The first scanning signal and the second scanning signal herein are in antiphase to each other.

In one preferred embodiment, the driving transistor further comprises a first electrode and a second electrode, the first electrode of the driving transistor is electrically coupled to the supply voltage, the second electrode of the driving transistor is electrically coupled to the LED. The first switching transistor further comprises a first electrode and a second electrode, the first electrode of the first switching transistor is electrically coupled to the second terminal of the storage capacitor, the second electrode of the first switching transistor is electrically coupled to the supply voltage. The second switching transistor further comprises a first electrode and a second electrode, the second electrode of the first switching transistor is electrically coupled to the first terminal of the storage capacitor, the second electrode of the second switching transistor is electrically coupled to the ground voltage. The third switching transistor further comprises a first electrode and a second electrode, the first electrode of the third switching transistor receiving the data voltage, the second electrode of the third switching transistor is electrically coupled to the first terminal of the storage capacitor.

In one preferred embodiment, each of the control electrodes is a gate, and each of the first electrodes and the second electrodes is a source or a drain.

The control electrode of the first switching transistor and the control electrode of the third switching transistor are electrically coupled to a first scanning line, and the control electrode of the second switching transistor is electrically coupled to a second scanning line, and the first electrode of the third switching transistor is electrically coupled to a data line.

In one preferred embodiment, each of the driving transistor, the first switching transistor, second switching transistor, and the third switching transistor is a P-type organic thin-film transistor.

In the preferred embodiment, turn-on/cut-off states of the first switching transistor and the third switching transistor are opposite to a turn-on/cut-off state of the second switching transistor.

To achieve another objective, a method for driving the above-mentioned pixel circuit provided by the present invention includes the steps of: providing a first scanning signal to the control electrodes of the first switching transistor and the third switching transistor for connecting the control electrode of the driving transistor to each other and for connecting the first terminal of the storage capacitor and the data voltage to each other; and providing a second scanning signal to the second switching transistor for connecting the first terminal of the storage capacitor and the ground voltage to each other; wherein the first scanning signal and the second scanning signal are in antiphase to each other.

In one preferred embodiment, turn-on/cut-off states of the first switching transistor and the third switching transistor are opposite to a turn-on/cut-off state of the second switching transistor. The driving transistor is at the cut-off state when the first switching transistor and the third switching transistor are at the turn-on state; the driving transistor is at the turn-on state for driving the LED to illuminate when the first switching transistor and the third switching transistor are at the cut-off state. Moreover, when the driving transistor is at the turn-on state, the first terminal of the storage capacitor has the ground voltage, and the second terminal of the storage capacitor has the supply voltage minus the data voltage.

The embodiments of the present invention by means of the designs of 4T1C and all P-type organic thin-film transistors can make the pixel current I_{OLED} which passes through the LED independent to the supply voltage Vdd. As a result, the pixel circuit and the driving method of the present invention can effectively improve the problem of the non-uniformity in the panel due to the voltage drop of the wires. In addition, the designs having the all P-type organic thin-film transistors enables the manufacturing processes thereof simpler; thus, a more uniform component characteristic can be obtained. In addition, the pixel circuit of the present invention does not need to employ the conventional coding manner to compensate, so it is applicable to the high-definition displays, thereby achieving the objective of the present invention.

It is to be understood that both the foregoing general description and the following detailed description of the present invention are exemplary and explanatory and are intended to provide further explanation of the invention as claimed.

### BRIEF DESCRIPTION OF THE DRAWINGS

FIG. 1 depicts a schematic drawing illustrating a conventional pixel circuit of an AMOLED;

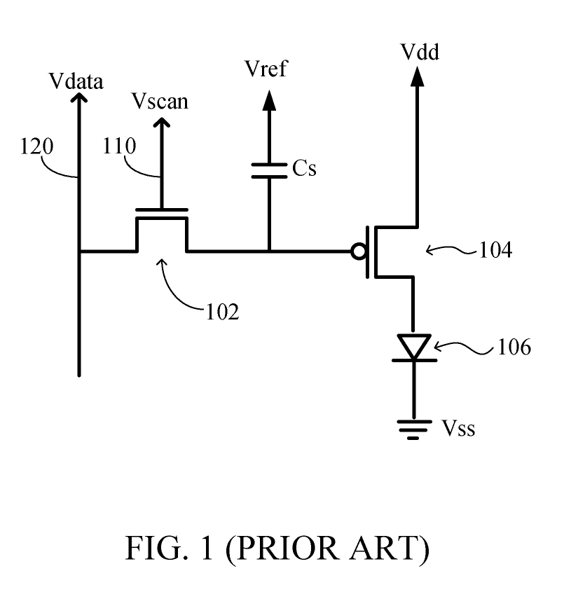

FIG. 2 depicts a circuit diagram illustrating an AMOLED in one preferred embodiment of the present invention;

FIG. 3 depicts a timing chart illustrating a driving method according to the embodiment;

FIG. 4 depicts an equivalent circuit diagram illustrating a pixel circuit of the embodiment during a reset period; and

FIG. 5 depicts an equivalent circuit diagram illustrating the pixel circuit of the embodiment during a luminous period.

### DETAILED DESCRIPTION OF THE INVENTION

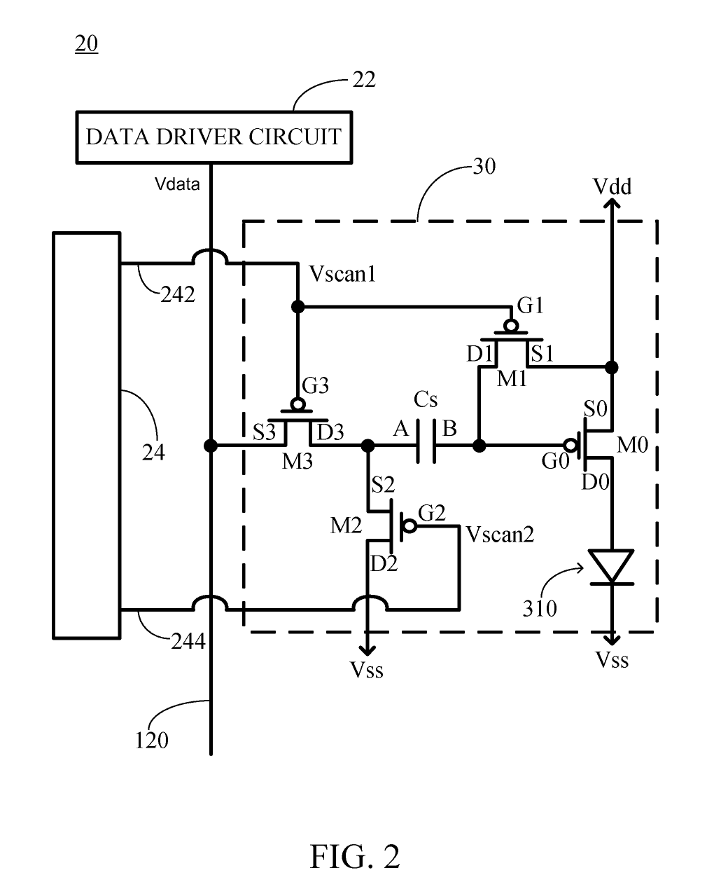

Referring to FIG. 2, FIG. 2 depicts a circuit diagram illustrating an AMOLED in one preferred embodiment of the present invention. The AMOLED 20 includes a data driver circuit 22, a scan driver circuit 24, and a plurality of pixel circuits 30, in which only a single pixel circuit 30 is depicted for clarity. The data driver circuit 22 provides a data signal Vdata via a data line 120, and the scan driver circuit 24 provides a first scanning signal Vscan1 and a second scanning signal Vscan2 respectively via a first scanning line 242 and a second scanning line 244.

In the embodiment, the pixel circuit 30 includes an LED 310, a storage capacitor Cs, a driving transistor M0, a first switching transistor M1, a second switching transistor M2, and a third switching transistor M3. Preferably, the LED 310 is an organic LED. Each of said transistors M0 to M3 has a control electrode, a first electrode and a second electrode. Preferably, each of the control electrodes is a gate G, and each of the first electrodes and the second electrodes is a source S or a drain D. The storage capacitor Cs has a first terminal A and a second terminal B.

The driving transistor M0 is utilized for driving the LED 310 to illuminate. Specifically, the gate G0 of the driving transistor M0 is electrically coupled to the second terminal B of the storage capacitor Cs for controlling connection/disconnection between a supply voltage Vdd and the LED 310. Furthermore, the source S0 of the driving transistor M0 is electrically coupled to the supply voltage Vdd, and the drain D0 of the driving transistor M0 is electrically coupled to an anode of the LED 310. Preferably, the driving transistor M0 is a P-type organic thin-film transistor.

The gate G1 of the first switching transistor M1 receives a first scanning signal Vscan1 to control connection/disconnection between the gate G0 of the driving transistor M0 and the supply voltage Vdd. Furthermore, the gate G1 of the first switching transistor M1 is electrically coupled to the first scanning line 242, and the drain D1 of the first switching transistor M1 is electrically coupled to the second terminal B of the storage capacitor Cs, and the source S1 of the first switching transistor M1 is electrically coupled to the supply voltage Vdd. Preferably, the first switching transistor M1 is a P-type organic thin-film transistor.

The gate G2 of the second switching transistor M2 receives the second scanning signal Vscan2 and controls connection/disconnection between the first terminal A of the storage capacitor Cs and a ground voltage Vss. Furthermore, the gate G2 of the second switching transistor M2 is electrically coupled to the second scanning line 244, and the source S2 of the second switching transistor M2 is electrically coupled to the first terminal A of the storage capacitor Cs, and the drain D2 of the second switching transistor M2 is electrically coupled to the ground voltage Vss. Preferably, the second switching transistor M2 is a P-type organic thin-film transistor.

The gate G3 of the third switching transistor M3 receives the first scanning signal Vscan1 and controls connection/disconnection between the first terminal A of the storage capacitor Cs and the data voltage. Furthermore, the gate G3 of the third switching transistor M3 is electrically coupled to the first scanning line 242, and the source S3 of the third switching transistor M3 is electrically coupled to the data line 120 and receives the data voltage Vdata, and the drain D3 of the third switching transistor M3 is electrically coupled to the first terminal A of the storage capacitor Cs. Preferably, the third switching transistor M3 is a P-type organic thin-film transistor.

The first scanning signal Vscan1 and the second scanning signal herein Vscan2 are in antiphase to each other, so that turn-on/cut-off states of the first switching transistor M1 and the third switching transistor M3 are opposite to a turn-on/cut-off state of the second switching transistor M2. It is worth mentioning that an electric current can not pass through the transistor in the cut-off state, and an electric current can pass through the transistor in the turn-on state.

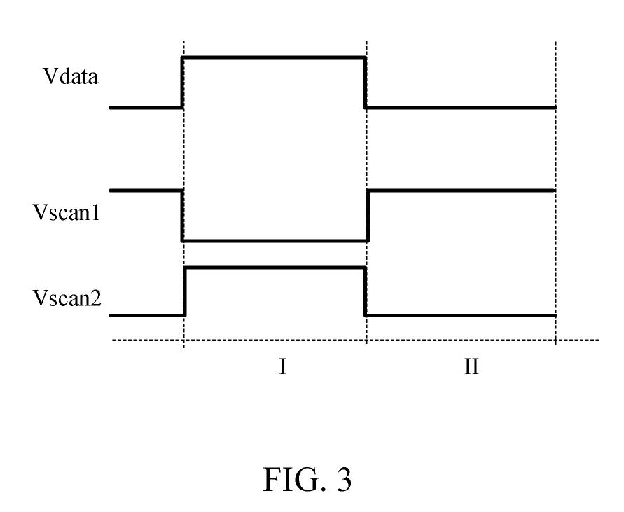

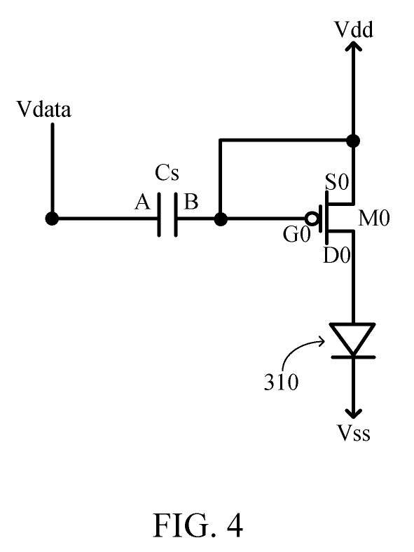

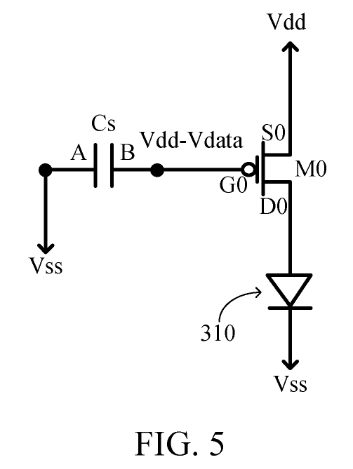

The driving method of the pixel circuit 30 in the embodiment will be explained in detail accompanying with FIG. 2 to FIG. 5 in the following. FIG. 3 herein depicts a timing chart illustrating a driving method according to the embodiment, and a driving process includes a reset period I and a luminous period II in a time frame. FIG. 4 depict an equivalent circuit diagram illustrating the pixel circuit 30 of the embodiment during the reset period I, and FIG. 5 depict an equivalent circuit diagram illustrating the pixel circuit 30 of the embodiment during the luminous period II.

The driving method of the pixel circuit 30 of the preferred embodiment includes the reset period I and the luminous period II. Referring to FIG. 2, FIG. 3 and FIG. 4, in the reset period I, the scan driver circuit 24 provides the first scanning signal Vscan1 to the gates G1 and G3 of the first switching transistor M1 and the third switching transistor M3. Meanwhile, the scan driver circuit 24 provides the second scanning signal Vscan2 to the gate G2 of the second switching transistor M2. The first scanning signal Vscan1 and the second scanning signal herein Vscan2 are in antiphase to each other, so that turn-on/cut-off states of the first switching transistor and the third switching transistor are opposite to a turn-on/cut-off state of the second switching transistor. Because the above-mentioned transistors M0 to M3 are all P-type transistors, they are in the cut-off states at a high level, and they are in the turn-on state at a low level. Accordingly, the gate G0 of the driving transistor M0 and the supply voltage Vdd are connected to each other, and the first terminal A of the storage capacitor Cs and the data voltage Vdata are connected to each other.

The electric potential at the gate G0 of the driving transistor M0 is reset in the reset period I, thereby preventing unknown gate voltage resulting in an operation mistake of the pixel circuit. Therefore, the driving transistor M0 is at the cut-off state when the first switching transistor M1 and the third switching transistor M3 are at the turn-on state. Specifically, the electric potential at the gate G0 of the driving transistor M0 is the same to the supply voltage Vdd, so the gate-source voltage Vsg (i.e., Vs−Vg, where Vs is the supply voltage Vdd, and Vg is also the supply voltage Vdd) equal to 0. The driving transistor M0 is in the cut-off state, and the LED 310 does not illuminate.

Referring to FIG. 3 and FIG. 5, in the luminous period II, the scan driver circuit 24 provides the second scanning signal Vscan2 to the second switching transistor M2. Meanwhile, the scan driver circuit 24 provides the first scanning signal Vscan1 to the gates G1 and G3 of the first switching transistor M1 and the third switching transistor M3, so that the first terminal A of the storage capacitor Cs and the ground voltage Vss are connected to each other. The first scanning signal Vscan1 and the second scanning signal herein Vscan2 are in antiphase to each other.

In a transient state between the reset period I and the luminous period II, charges Q of the storage capacitor Cs and the capacitor value C are unchanged due to the law of charge conservation. It can be seen from capacitor equation Q=CV that a cross-voltage Vab between the first terminal A and the second terminal B of the storage capacitor Cs remains unchanged. The cross-voltage Vab is Vdata−Vdd in the reset period I, and the voltage of the first terminal A of the storage capacitor Cs is the ground voltage Vss (assumed to be 0 volt) at a moment of transiting to the luminous period II. It can be seen from the foregoing that the voltage of the second terminal B of the storage capacitor Cs must be −(Vdata−Vdd), that is to say, the supply voltage Vdd minus the data voltage Vdata (i.e., 0−[−(Vdata−Vdd)]) only can make the cross-voltage Vab unchanged.

The driving transistor M0 is in the turn-on state when the first switching transistor M1 and the third switching transistor M3 are at the cut-off state. Specifically, the electric potential at the gate G0 of the driving transistor M0 is the same to that of the second terminal B of the storage capacitor Cs, so the gate-source voltage Vsg (i.e., Vs−Vg, where Vs is the supply voltage Vdd, and Vg is also the Vdd−Vdata) equal to Vdata. The driving transistor M0 is in the turn-on state, and the LED 310 to illuminate at the same time. In addition, the gate-source voltage Vsg=Vdata is brought into the equation, I_{OLED}=K×(Vsg−|Vth|)², an equation, I_{OLED}=K×(Vdata−|Vth|)², without the supply voltage Vdd can be obtained. Therefore, the supply voltage Vdd that relates to the voltage drop of the wires can be removed, thereby solving the problem of the non-uniformity in the panel.

It should be noted that types of the transistors M0 to M3 in the pixel circuit 30 of the above-mentioned embodiment can be altered, or relations of the sources and the drains of the transistors M0 to M3 can be exchanged by a person skilled in the art.

In summary, the embodiments of the present invention by means of the designs of 4T1C and all P-type organic thin-film transistors can make the pixel current I_{OLED} which passes through the LED 310 independent to the supply voltage Vdd. Therefore, the pixel circuit 30 and the driving method of the present invention can effectively improve the problem of the non-uniformity in the panel due to the voltage drop of the wires. In addition, the designs having the all P-type organic thin-film transistors enables the manufacturing processes thereof simpler; thus, more uniform component characteristics are available. Moreover, the pixel circuit 30 of the present invention does not need to employ the conventional coding manner to compensate, so it can apply to the high-definition displays.

While the preferred embodiments of the present invention have been illustrated and described in detail, various modifications and alterations can be made by persons skilled in this art. The embodiment of the present invention is therefore described in an illustrative but not restrictive sense.

What is claimed is:

1. A pixel circuit, comprising:
a light emitting diode (LED);
a storage capacitor having a first terminal and a second terminal;
a driving transistor, having a control electrode, for driving the LED to illuminate, the control electrode of the driving transistor electrically coupled to the second terminal of the storage capacitor for controlling connection/disconnection between a supply voltage and the LED;
a first switching transistor having a control electrode, which receives a first scanning signal for controlling connection/disconnection between the control electrode of the driving transistor and the supply voltage;
a second switching transistor having a control electrode, which receives a second scanning signal for controlling connection/disconnection between the first terminal of the storage capacitor and a ground voltage; and
a third switching transistor having a control electrode, which receives the first scanning signal for controlling connection/disconnection between the first terminal of the storage capacitor and a data voltage;
wherein the first scanning signal and the second scanning signal are in antiphase to each other.

2. The pixel circuit of claim 1, wherein the driving transistor further comprises a first electrode and a second electrode, the first electrode of the driving transistor is electrically coupled to the supply voltage, the second electrode of the driving transistor is electrically coupled to the LED; the first switching transistor further comprises a first electrode and a second electrode, the first electrode of the first switching transistor is electrically coupled to the second terminal of the storage capacitor, the second electrode of the first switching transistor electrically coupled to the supply voltage; the second switching transistor further comprises a first electrode and a second electrode, the second electrode of the first switching transistor is electrically coupled to the first terminal of the storage capacitor, the second electrode of the second switching transistor is electrically coupled to the ground voltage; and the third switching transistor further comprises a first electrode and a second electrode, the first electrode of the third switching transistor receives the data voltage, the second electrode of the third switching transistor is electrically coupled to the first terminal of the storage capacitor.

3. The pixel circuit of claim 2, wherein each of the control electrodes is a gate, and each of the first electrodes and the second electrodes is a source or a drain.

4. The pixel circuit of claim 1, wherein the control electrode of the first switching transistor and the control electrode of the third switching transistor are electrically coupled to a first scanning line, and the control electrode of the second switching transistor is electrically coupled to a second scanning line, and the first electrode of the third switching transistor is electrically coupled to a data line.

5. The pixel circuit of claim 1, wherein each of the driving transistor, the first switching transistor, the second switching transistor, and the third switching transistor is a P-type organic thin-film transistor.

6. The pixel circuit of claim 1, wherein turn-on/cut-off states of the first switching transistor and the third switching transistor are opposite to a turn-on/cut-off state of the second switching transistor.

7. A method for driving a pixel circuit, the pixel circuit comprising an LED (light emitting diode), a storage capacitor, a driving transistor, a first switching transistor, a second switching transistor, and a third switching transistor, the storage capacitor having a first terminal and a second terminal, the driving transistor for driving the LED to illuminate and for controlling connection/disconnection between a supply voltage and the LED, a control electrode of the first switching transistor controlling connection/disconnection between a control electrode of the driving transistor and the supply voltage, a control electrode of the second switching transistor controlling connection/disconnection between the first terminal of the storage capacitor and a ground voltage, a control electrode of the third switching transistor controlling connection/disconnection between the first terminal of the storage capacitor and a data voltage, the method comprising the steps of:
providing a first scanning signal to the control electrodes of the first switching transistor and the third switching transistor for connecting the control electrode of the driving transistor to each other and for connecting the first terminal of the storage capacitor and the data voltage to each other; and
providing a second scanning signal to the second switching transistor for connecting the first terminal of the storage capacitor and the ground voltage to each other; wherein the first scanning signal and the second scanning signal are in antiphase to each other.

8. The method of claim 7, wherein the first switching transistor and the third switching transistor have turn-on/cut-off states being opposite to a turn-on/cut-off state of the second switching transistor.

9. The method of claim 8, wherein the driving transistor is at the cut-off state when the first switching transistor and the third switching transistor are at the turn-on state; the driving transistor is at the turn-on state for driving the LED to illuminate when the first switching transistor and the third switching transistor are at the cut-off state.

10. The method of claim 9, wherein, the first terminal of the storage capacitor has the ground voltage, and the second terminal of the storage capacitor has the supply voltage minus the data voltage when the driving transistor is at the turn-on state.
